(19) United States
(12) Patent Application Publication
(10) Pub. No.: US 2021/0190335 A1
(43) Pub. Date: Jun. 24, 2021

(54) DEHUMIDIFIER WITH THERMOSIPHON ARRANGEMENT

(71) Applicant: Dantherm A/S, Skive (DK)

(72) Inventors: Orla Lang Sørensen, Spøttrup (DK); Richard James Carrington, Essex (GB)

(21) Appl. No.: 16/757,340

(22) PCT Filed: Oct. 15, 2018
(86) PCT No.: PCT/DK2018/050259

§ 371 Date: Apr. 17, 2020

(30) Foreign Application Priority Data
Oct. 20, 2017 (DK) PA 2017 70797

(51) Int. Cl. F24F 3/14; F28D 1/02

(52) U.S. Cl. CPC F24F 3/14; F28D 2021/0038; F24F 2003/1446; F28D 1/0226

(57) ABSTRACT

Herein is disclosed a dehumidifier for dehumidifying ambient air in an airstream from an inlet to an exhaust from an outlet in a housing. The dehumidifier comprises an evaporator having an evaporator downstream face and an evaporator upstream face; and downstream 5 from the evaporator a condenser having a condenser downstream face and a condenser upstream face. The dehumidifier further has a thermosiphon arrangement configured to be arranged with a thermosiphon evaporator part upstream from the evaporator and a thermosiphon condenser part upstream from the condenser and downstream from the evaporator. The thermosiphon arrangement comprises a thermosiphon block configured for a refrigerant to communicate between a first header and a second header interconnected with a fluid communicator arrangement being multiple tubes, wherein the thermosiphon block is sealed and contains the refrigerant.

### FIELD OF THE INVENTION

The present invention relates to a dehumidifier for dehumidifying ambient air in an airstream from an inlet to an exhaust from an outlet in a housing. The dehumidifier comprises an evaporator having an evaporator downstream face and an evaporator upstream face; and downstream from the evaporator a condenser having a condenser downstream face and a condenser upstream face. The dehumidifier further has a thermosiphon arrangement configured to be arranged with a thermosiphon evaporator part upstream from the evaporator and a thermosiphon condenser part upstream from the condenser and downstream from the evaporator.

### BACKGROUND OF THE INVENTION

Dehumidifiers are generally known in the art. In particular dehumidifiers comprising an active evaporator and condenser arranged in a housing to dehumidify ambient air.

Such dehumidifiers are typically designed or dimensioned to operate according to certain ambient conditions.

FR2672970 describes a dehumidifier which has an evaporator upstream from a condenser, a thermosiphon evaporator part upstream from the evaporator and a thermosiphon condenser part downstream from the evaporator and upstream from the condenser. The thermosiphon evaporator part is connected to the thermosiphon condenser part via a single tube, having a significant part of the whole tube external from both thermosiphon parts and, thus, increases the size of the entire installation. Furthermore, the tube parts external to either thermosiphon part are neither heated nor cooled and thus do not contribute to the purpose of the thermosiphon as such, but the external tube parts increase the overall weight and complexity of the installation.

### OBJECT OF THE INVENTION

It is an objective to improve effectiveness of a dehumidifier at a certain operational condition or over a range of operational conditions.

It is an objective to decrease the size and/or weight of the active evaporator and condenser parts of a dehumidifier.

It is an objective to increase the range of operational ambient conditions whilst maintaining or even reduce the size and power consumption of the active part.

It is a further objective to reduce complexity of a dehumidifier.

### DESCRIPTION OF THE INVENTION

An object is achieved by a dehumidifier for dehumidifying ambient air in an airstream from an inlet to an exhaust from an outlet in a housing. The dehumidifier comprises an evaporator having an evaporator downstream face and an evaporator upstream face; and downstream from the evaporator a condenser having a condenser downstream face and a condenser upstream face.

The condenser may be at a higher gravitational level than the evaporator. It is understood that the housing is configured to be positioned in a top-down orientation relative to gravity.

The evaporator and the condenser may be interconnected and arrangements are generally known in the art and a person skilled in the art will be able to construct various implementations of the evaporator and condenser. In the housing walls, insulation or alike separators may be installed to establish the airflow so that the airflow is from the inlet to the outlet via the evaporator and the condenser.

The dehumidifier further has a thermosiphon arrangement configured to be arranged with a thermosiphon evaporator part upstream from the evaporator and a thermosiphon condenser part upstream from the condenser and downstream from the evaporator.

The evaporator and condenser may be considered active and driven by active circulation of a refrigerant and by a compressor. The thermosiphon may be considered passive.

A dehumidifier having a thermosiphon arrangement is thus more effective and allows for reduction in size, power consumption or both of the active evaporator and condenser.

Furthermore, the thermosiphon arrangement evaporator part may pre-condition the thermal conditions of the airstream before interacting with the evaporator and thus reduce span of thermal conditions necessary for the evaporator to operate under.

Likewise the thermosiphon condenser part may pre-condition the thermal conditions of the airstream before interacting with the condenser and thus reduce the span of thermal conditions necessary for the condenser to operate under.

The reduction of span of operational conditions may allow for simpler control or regulation systems and thus overall reduce complexity.

Thus the evaporator is sandwiched between the thermosiphon arrangement so that the evaporator is preceded by a thermosiphon evaporator part and followed by a thermosiphon condenser part in the airstream. Again walls, insulation and separators may be installed to ensure that the airflow passes the thermosiphon arrangement.

In an embodiment the thermosiphon arrangement has a thermosiphon evaporator part having a first header and a second header and in between a fluid communicator arrangement. The fluid communicator arrangement may be with multiple MPE-tubes optionally with fins in between. The thermosiphon condenser part may be constructed using the same components. The thermosiphon evaporator part may be interconnected with the thermosiphon condenser part.

In an embodiment the condenser header of the thermosiphon condenser part may be in fluid connection with the condenser header of the thermosiphon evaporator part and the evaporator header of the thermosiphon condenser part may be in fluid connection with the evaporator header of the thermosiphon evaporator part. The condenser headers are arranged above the evaporator headers thus creating a circulating flow of a refrigerant during operation.

In an embodiment the condenser thermosiphon part is in fluid communication with the evaporator thermosiphon part by the evaporator header of the condenser thermosiphon part being connected to the condenser header of the evaporator part. Again a person skilled in the art will be able to position the respective headers relative to each other so as to create the effects of a thermosiphon.

The respective evaporator and condenser thermosiphon parts may comprise a thermosiphon block configured for a refrigerant to circulate between a first header, such as an evaporator header, and a second header, such as condenser header, interconnected with a fluid communicator arrangement. The communicator arrangement may comprise multiple MPE-tubes with fins in-between.

In an embodiment, the thermosiphon arrangement comprises a thermosiphon block configured for a refrigerant to communicate between a first header, such as an evaporator header, and a second header, such as a condenser header. The first and second headers are connected with a fluid communicator arrangement and the thermosiphon block is sealed and contains the refrigerant.

By using a sealed thermosiphon block a particular compact dehumidifier is achieved. The thermosiphon block results in a great reduction or elimination of additional piping or fluid connections. The thermosiphon block is furthermore simple and reduces requirements of brazing. Furthermore, a thermosiphon block is easy to clean or maintain and even to replace, since a dirty or defect block can easily slide out and back in.

Thus in effect, a thermosiphon block, in particular the thermosiphon evaporator part of the thermosiphon block may serve as a filter for the evaporator. Thereby the combined effect is extending operational time at or within certain effectiveness requirements.

The communicator arrangement may be multiple tubes, such as MPE-tubes. There may be fins in-between the tubes.

In an embodiment of the fluid communicator arrangement, the thermosiphon block has a part that is a thermosiphon evaporator part having a thermosiphon evaporator part downstream face substantially facing the evaporator upstream face.

In an embodiment of the fluid communicator arrangement, the thermosiphon block has a part that is a thermosiphon condenser part having a thermosiphon condenser part downstream face substantially facing the condenser upstream face.

The faces may be substantially arranged equidistant to each other. The faces may be structurally close to each other. By close is understood that the thermosiphon evaporator part downstream face is arranged as close to the evaporator upstream face taking headers and frames into account. The faces may be substantially of the same area. The thermosiphon evaporator face may be larger than the face of the evaporator.

The thermosiphon evaporator part downstream face and the thermosiphon condenser part upstream face is the same face of the thermosiphon block. The opposite face of the thermosiphon block is the thermosiphon evaporator part upstream face and the thermosiphon condenser part downstream face.

The evaporator face and the condenser face projection onto the faces of the thermosiphon block may define the evaporator and condenser part of the thermosiphon block. There may be a zone in-between, which zone will be a thermal transition zone or an adiabatic zone.

The faces may be provided arranged to create or result in an adiabatic zone that is as small as possible.

There may be walls, insulation or alike separation means arranged to further separate the evaporator part from the condenser part.

In an aspect of the dehumidifier as having a first thermosiphon arrangement as disclosed there, in addition to the first thermosiphon arrangement a dehumidifier may further comprise a second thermosiphon arrangement. This second thermosiphon arrangement may be arranged with second thermosiphon evaporator part downstream from first thermosiphon evaporator part, i.e. between the first thermosiphon evaporator part and the evaporator, and a second thermosiphon condenser part upstream from the first thermosiphon condenser part/side, i.e. between the evaporator and the first thermosiphon condenser part/side.

Besides an incremental effect for a certain thermal condition of the airstream, say at certain temperature and relative humidity, e.g. T28° C. and RH60%, an arrangement with two thermosiphon arrangements have shown to further and unexpectedly to improve effectiveness at an additional thermal condition, e.g. T20° C. and RH50%.

In example, having a dehumidifier in a configuration comprising only the active evaporator and condenser having an operational efficiency indexed 100 at particular operating point of ambient conditions (e.g. [T10° C.,RH50%], . . . [T20° C.,RH50%], . . . , [T28° C.,RH60%], . . . [T35° C.,RH80%]).

Then for [T28° C.,RH60%] using only one thermosiphon arrangement results in an index 141; and using two thermosiphon arrangements result in an index 146.

However, for [T20° C.,RH50%] using only one thermosiphon arrangement results in an index 138; but using two thermosiphon arrangements result in an index 152.

Hence using two thermosiphon arrangements has resulted in not only greater, even incremental, but also reduced relative span of effectiveness over a range of thermal conditions. Thus two thermosiphon arrangements allow for a simpler or more standardised configuration of the active evaporator and condenser arrangement to be used.

Thus using two thermosiphon arrangements improves the overall operational range of ambient conditions in which the dehumidifier will work using the same configuration of the active evaporator and condenser configuration.

In an aspect of the dehumidifier with two thermosiphon arrangements, the first thermosiphon arrangement is a first thermosiphon block and the second thermosiphon arrangement is a second thermosiphon block.

The thermosiphon block being sealed and in nature simple and having a flat design form allows for two thermosiphon arrangements to easily be implemented to achieve the additional advantages described whilst maintaining a compact, e.g. flat design.

The two thermosiphon blocks may be sandwiched and aligned. They may be stacked. The two thermosiphon blocks may be identical. Each thermosiphon blocks may have connections to be stacked. The two thermosiphon blocks may form a common block as the thermosiphon arrangement.

A person skilled in the art will configure the thermosiphon blocks with the condenser headers in an upper part of the housing and the evaporator headers in a lower part of the housing. The thermosiphon blocks may be tilted in the housing creating a volume for the respective evaporator and condenser.

In an embodiment the first thermosiphon block and the second thermosiphon block are sandwiched with
the first thermosiphon evaporator part downstream face substantially facing the second thermosiphon evaporator part upstream face;
the first thermosiphon condenser part upstream face substantially facing the second thermosiphon condenser part downstream face;
the second thermosiphon evaporator part downstream face substantially facing the evaporator upstream face; and
the first thermosiphon condenser part downstream face substantially facing the condenser upstream face.

In general the dehumidifier as disclosed with a first thermosiphon arrangement may be constructed as a dehumidifier, which in addition to the first thermosiphon arrangement further comprising N−1 thermosiphon arrangements. For i=2 to N; each i'th thermosiphon arrangement arranged with an i'th thermosiphon evaporator parte downstream from the i−1 thermosiphon evaporator part and an i'th thermosiphon condenser part upstream from the i−1 thermosiphon condenser part.

That is a dehumidifier having an evaporator and a condenser and in total N thermosiphon arrangements.

Such dehumidifier has the first thermosiphon arrangement as a first thermosiphon block and the Nth thermosiphon arrangement is an Nth thermosiphon block.

In an embodiment, all N thermosiphon blocks are sandwiched. Such N-thermosiphon block arrangement or common block has the (i−1)'th thermosiphon evaporator part downstream face substantially facing the i'th thermosiphon evaporator part upstream face; the (i−1)'th thermosiphon condenser part upstream face substantially facing the i'th thermosiphon condenser part downstream face; the Nth thermosiphon evaporator part downstream face substantially facing the evaporator upstream face; and the first thermosiphon evaporator part downstream face substantially facing the condenser upstream face.

The thermosiphon arrangements, including a thermosiphon block, may use a refrigerant readily available. A refrigerant may be chosen amongst refrigerants such as: R 1234 ZE, R 1234 YF, R 1234 A, R 290, R 32, R 152 A, R 444 B, R 444 A, R 407 C, R 410 A, R 454 C, Water, Water with Ethanol, Ethanol, Water with isopropanol, Water with glycol, or Isopropanol. The list is not complete and equivalents may be used. Likewise mixtures and dilutions may be used.

In various aspects the dehumidifier may comprise a separator separating the evaporator parts from the condenser parts and configured to guide the airstream from the evaporators to the condenser in the housing.

As outlined the separator may be a wall or a wall arrangement. Parts may be insulated to better define the respective evaporator and condenser parts as will be apparent from the figures the walls may be easily installed or modified starting from the suggested embodiments. A person skilled in the art starting from the suggested embodiments will find it natural to perform some experimentation to optimise the airstream and to reduce pressure drops.

Finally, a person skilled in the art will be able to implement collectors, drains or other means of handling water extracted during dehumidification.

### DESCRIPTION OF THE DRAWING

Embodiments of the invention will be described in the figures, whereon:

FIG. 1 illustrates a known dehumidifier;

FIG. 2 illustrates a dehumidifier comprising a thermosiphon arrangement;

FIG. 3 illustrates a dehumidifier comprising two thermosiphon arrangements;

FIG. 4 illustrates a comparison of the previous three dehumidifiers;

FIG. 5 illustrates a thermosiphon arrangement configured to circulate a refrigerant between a condenser and an evaporator;

FIG. 6 illustrates an embodiment of a thermosiphon arrangement as a thermosiphon block;

FIG. 7 illustrates an embodiment of a thermosiphon arrangement;

FIG. 8 illustrates a dehumidifier comprising a thermosiphon arrangement based on a thermosiphon block;

FIG. 9 illustrates a dehumidifier comprising two thermosiphon blocks as the thermosiphons arrangement;

FIG. 10 illustrates a dehumidifier comprising N thermosiphon blocks a the thermosiphons arrangement;

FIG. 11 illustrates a dehumidifier comprising a bent thermosiphons arrangement; and

FIG. 12 illustrates a dehumidifier projected onto an airstream;

### DETAILED DESCRIPTION OF THE INVENTION

| No | Item |
|---|---|
| 10 | Ambient air |
| 20 | Exhaust |
| 100 | Dehumidifier |
| 110 | Inlet |
| 114 | Upstream |
| 115 | Airstream |
| 116 | Downstream |
| 120 | Outlet |
| 130 | Housing |
| 140 | Separator |
| E - 210 | Evaporator |
| 211 | Evaporator Downstream face |
| 212 | Evaporator Upstream face |
| C - 220 | Condenser |
| 221 | Condenser Downstream face |
| 222 | Condenser Upstream face |
| 300 | Thermosiphon arrangement |
| 302 | Refrigerant |
| TS-E - 310 | Thermosiphon evaporator part |
| 311 | Thermosiphon evaporator part downstream face |
| 312 | Thermosiphon evaporator part upstream face |
| TS-C - 320 | Thermosiphon condenser part |
| 321 | Thermosiphon condenser part downstream face |
| 322 | Thermosiphon condenser part upstream face |
| 330 | Fluid connection |
| 400 | Thermosiphon block |
| 410 | Header |
| 411 | First header - evaporator part header |
| 412 | Second header - condenser part header |
| 420 | Fluid communicator arrangement |
| 440 | Adiabatic zone |

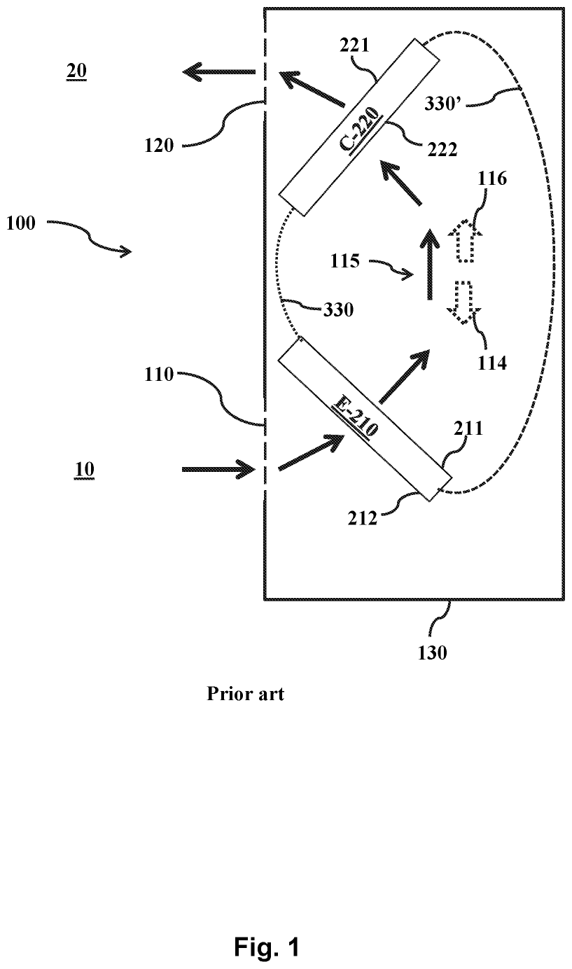

FIG. 1 illustrates a known dehumidifier 100. The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more walls (not shown) to control the airflow 115 such that the pressure loss through the dehumidifier 100 is as low as possible. The skilled person would know how to position the one or more walls.

The dehumidifier 100 has along the airstream 115, in the following order, an evaporator E-210 and a condenser C-220. The condenser C-220 is positioned at a higher gravitational level of the evaporator E-210.

The evaporator E-210 will actively cool the ambient air 10 below the dew point and the condenser C-220 will afterwards actively heat the dehumidified air. The evaporator E-210 and the condenser C-220 are interconnected by first a fluid connection 330 and, optional, a second fluid connection 330′, thereby creating a circuit such that a refrigerant 302 may flow between the elements. The skilled person would know that a not shown compressor is part of the circuit.

The circuit are not shown in the other figures, but the skilled person would know that the circuit are present in the systems the figures represent.

The evaporator E-210 has an evaporator downstream face 211 facing the downstream 116 and an evaporator upstream face 212 facing the upstream 114. The evaporator upstream face 212 substantially faces the inlet 110.

The condenser C-220 has a condenser downstream face 221 facing the downstream 116 and a condenser upstream face 222 facing the upstream 114. The condenser downstream face 221 substantially faces the outlet 120.

The evaporator downstream face 211 substantially faces the condenser upstream face 222.

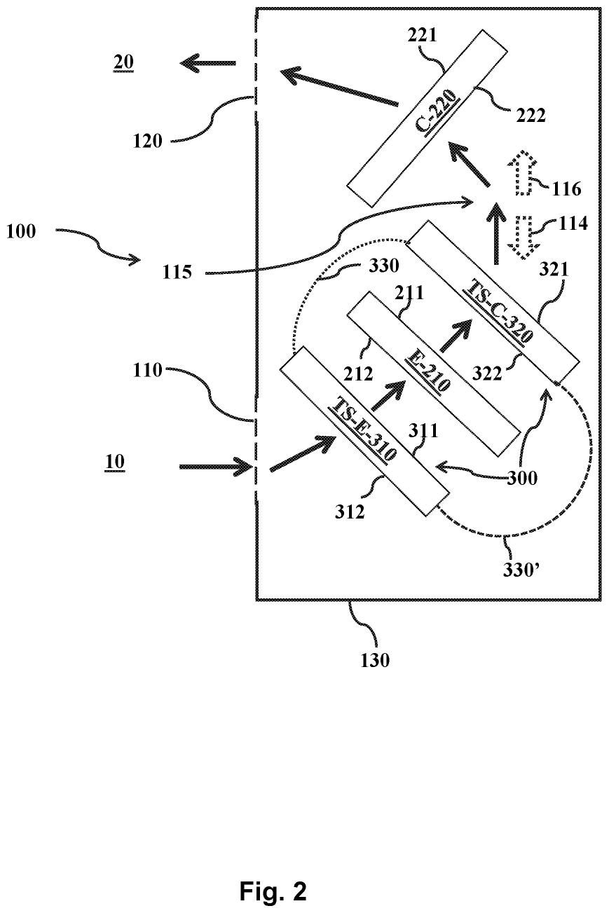

FIG. 2 illustrates a dehumidifier 100 comprising a thermosiphon arrangement 300. The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more walls (not shown) to control the airflow 115 such that the pressure loss through the dehumidifier 100 is as low as possible. The skilled person would know how to position the one or more walls.

The dehumidifier 100 has along the airstream 115 an evaporator E-210 and a condenser C-220. Although not shown, the evaporator E-210 and the condenser C-220 are interconnected, such that a refrigerant 302 may flow.

The evaporator E-210 has an evaporator downstream face 211 facing the downstream 116 and an evaporator upstream face 212 facing the upstream 114.

The condenser C-220 has a condenser downstream face 221 facing the downstream 116 and a condenser upstream face 222 facing the upstream 114.

The thermosiphon arrangement 300 comprises a thermosiphon evaporator part TS-E-310 and a thermosiphon condenser part TS-C-320. The thermosiphon evaporator part TS-E-310 and the thermosiphon condenser part TS-C-320 are interconnected by first a fluid connection 330 and, optional, a second fluid connection 330′, thereby creating a circuit such that a refrigerant 302 may flow between the elements.

The thermosiphon evaporator part TS-E-310 has a thermosiphon evaporator part downstream face 311 facing downstream 116 and a thermosiphon evaporator part upstream face 312 facing upstream 114.

The thermosiphon condenser part TS-C-320 has a thermosiphon condenser part downstream face 321 facing downstream 116 and a thermosiphon condenser part upstream face 322 facing upstream 114.

The evaporators 210, 310 and condensers 220, 320 are positioned as described below. It is seen that the thermosiphon evaporator part upstream face 312 substantially faces the inlet 110.

It is seen that the thermosiphon evaporator part downstream face 311 substantially faces the evaporator upstream face 212.

It is seen that the evaporator downstream face 211 substantially faces the thermosiphon condenser part upstream face 322.

It is seen that the thermosiphon condenser part downstream face 321 substantially faces the condenser upstream face 222.

It is seen that the condenser downstream face 221 substantially faces the outlet 120.

The evaporators 210, 310 and condensers 220, 320 are aligned such that the pressure loss through the dehumidifier 100 is kept at a minimum as pressure loss lowers the efficiency of the dehumidifier 100.

The thermosiphon arrangement 300 is a passive element. The thermosiphon evaporator part TS-E-310 will lower the temperature of the ambient air 10. The air temperature will be closer to the dew point and thus the work needed to be performed by the evaporator E-210 will be lower. The air will afterwards be heated by the thermosiphon condenser part TS-C-320, thereby ensuring flow of the refrigerant 302. Afterwards the active condenser C-220 will heat the dehumidified air.

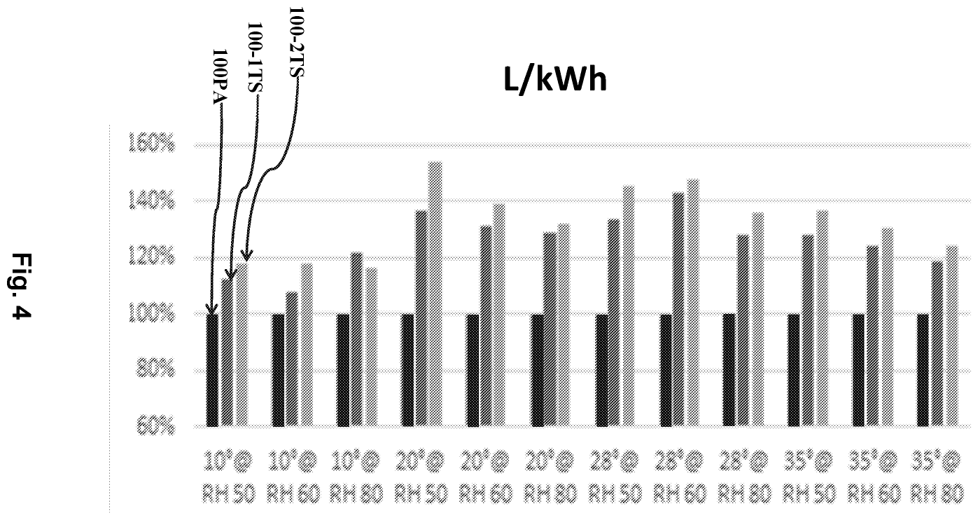

Tests have shown that the dehumidifier 100 comprising the thermosiphon arrangement 300 is more efficient relative to the standard dehumidifier 100 disclosed in FIG. 1. A comparison between the two embodiments is shown in FIG. 4.

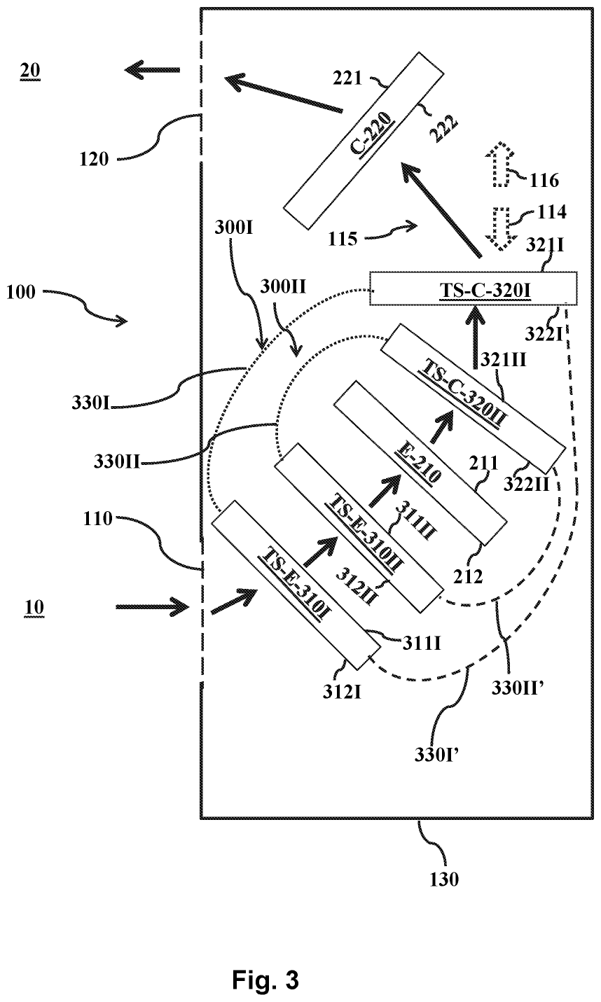

FIG. 3 illustrates a dehumidifier 100 comprising two thermosiphon arrangements 300I, 300II.

The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more walls (not shown) to control the airflow 115 such that the pressure loss through the dehumidifier 100 is as low as possible. The skilled person would know how to position the one or more walls.

The dehumidifier 100 has along the airstream 115 an evaporator E-210 and a condenser C-220. Although not shown, the evaporator E-210 and the condenser C-220 are interconnected, such that a refrigerant 302 may flow.

The evaporator E-210 has an evaporator downstream face 211 facing the downstream 116 and an evaporator upstream face 212 facing the upstream 114.

The condenser C-220 has a condenser downstream face 221 facing the downstream 116 and a condenser upstream face 222 facing the upstream 114.

Each thermosiphon arrangement 300I, 300II comprises a thermosiphon evaporator part TS-E-310I, TS-E-310II and a thermosiphon condenser part TS-C-320I, TS-C-320II. The thermosiphon evaporator part TS-E-310I, TS-E-310II and the thermosiphon condenser part TS-C-320I, TS-C-320II are interconnected by a fluid connection 330I, 330II and, optional, a second fluid connection 330I′, 330II′, thereby creating a circuit such that a refrigerant 302 may flow between the elements.

Each thermosiphon evaporator part TS-E-310I, TS-E-310II has a thermosiphon evaporator part downstream face 311I, 311II facing downstream 116 and a thermosiphon evaporator part upstream face 312I, 312II facing upstream 114.

Each thermosiphon condenser part TS-C-320I, TS-C-320II has a thermosiphon condenser part downstream face 321I, 321II facing downstream 116 and a thermosiphon condenser part upstream face 322I, 322II facing upstream 114.

The evaporators 210, 310I, 310II and condensers 220, 320I, 320II are positioned as described below.

It is seen that the thermosiphon evaporator part upstream face 312I substantially faces the inlet 110.

It is seen that the thermosiphon evaporator part downstream face 311I substantially faces thermosiphon evaporator part upstream face 312II.

It is seen that the thermosiphon evaporator part downstream face 311II substantially faces the evaporator upstream face 212.

It is seen that the evaporator downstream face 211 substantially faces the thermosiphon condenser part upstream face 322II.

It is seen that the thermosiphon condenser part downstream face 321II substantially faces thermosiphon condenser part upstream face 322I.

It is seen that the thermosiphon condenser part downstream face 321I substantially faces the condenser upstream face 222.

It is seen that the condenser downstream face 221 substantially faces the outlet 120.

The evaporators 210, 310I, 310II and condensers 220, 320I, 320II are aligned such that the pressure loss through the dehumidifier 100 is kept at a minimum as pressure loss lowers the efficiency of the dehumidifier 100.

The thermosiphon arrangements 300I, 300II are both passive elements. The thermosiphon evaporator parts TS-E-310I, TS-E-310II will lower the temperature of the ambient air 10. The air temperature will be closer to the dew point and thus the work needed to be performed by the evaporator E-210 will be lower. The air will afterwards be heated by the thermosiphon condenser parts TS-C-320I, TS-C-320II, thereby ensuring flow of the refrigerant 302. Afterwards the active condenser C-220 will heat the dehumidified air.

Tests have shown that the dehumidifier 100 comprising the two thermosiphon arrangements 300 is more efficient relative to the standard dehumidifier 100 disclosed in FIG. 1.

Tests have also shown the dehumidifier 100 comprising the two thermosiphon arrangements 300 is more efficient than the dehumidifier 100 disclosed in FIG. 2 in a broad range of temperature and relative humidity.

A comparison between the different embodiments is shown in FIG. 4.

FIG. 4 illustrates a comparison of the previous three dehumidifiers 100PA (FIG. 1), 100-1TS (FIG. 2) and 100-2TS (FIG. 3).

FIG. 4 discloses a graph having a first axis showing the various measuring points. The dehumidifiers 100PA, 100-1TS and 100-2TS have been measured at the temperatures 10° C., 20° C. 28° C. and 35° C. Each temperature point has been measured with a relative humidity (RH) of RH50%, RH60% and RH80%.

The second axis represents the amount water volume per kWh spent. The prior art dehumidifier 100PA has been used as a reference and has been set to 100% at each test point.

It is the industry standard to compare dehumidifiers at the point [T28° C., RH60%]. The dehumidifier 100-1TS shows an efficiency increase of 43% relative to the prior art. The dehumidifier 100-2TS increases the efficiency by only a few percentage points relative to the dehumidifier 100-1TS at the point [T28° C., RH60%].

However, at the points [T28° C., RH50%] and [T28° C., RH80%] the difference in efficiency between the two dehumidifiers is larger.

The dehumidifier 100-2TS is more efficient than the dehumidifier 100-1TS at all points, with the exception of point [10° C., RH80%]. The difference in efficiency is largest at point [20° C., RH50%].

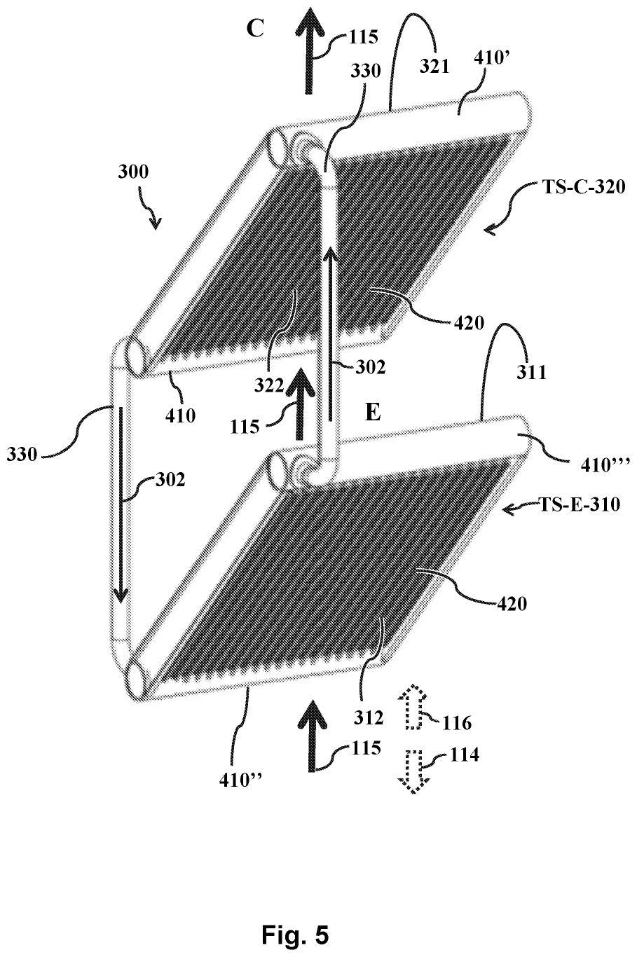

FIG. 5 illustrates a thermosiphon arrangement 300 configured to circulate a refrigerant 302 between a condenser TS-C-320 and an evaporator TS-E-310.

The thermosiphon condenser part TS-C-320 has two headers 410, 410′ interconnected by a fluid communications arrangement 420, where one header 410′ is at a higher gravitational level. There are means for guiding gaseous refrigerant to the condenser TS-C-320.

The thermosiphon evaporator part TS-E-310 has two headers 410″, 410′″ interconnected by a fluid communications arrangement 420, where one header 410′″ is at a higher gravitational level.

The thermosiphon evaporator part TS-E and the thermosiphon condenser part TS-C are shown to have headers 410 connected via fluid connections 330 as shown.

The fluid communications arrangements 420 are shown with MPEs with fins to cover an area as large as possible to efficiently convert heat from the airstream 115 indicated to exemplify the thermosiphon arrangement 300 during intended operation.

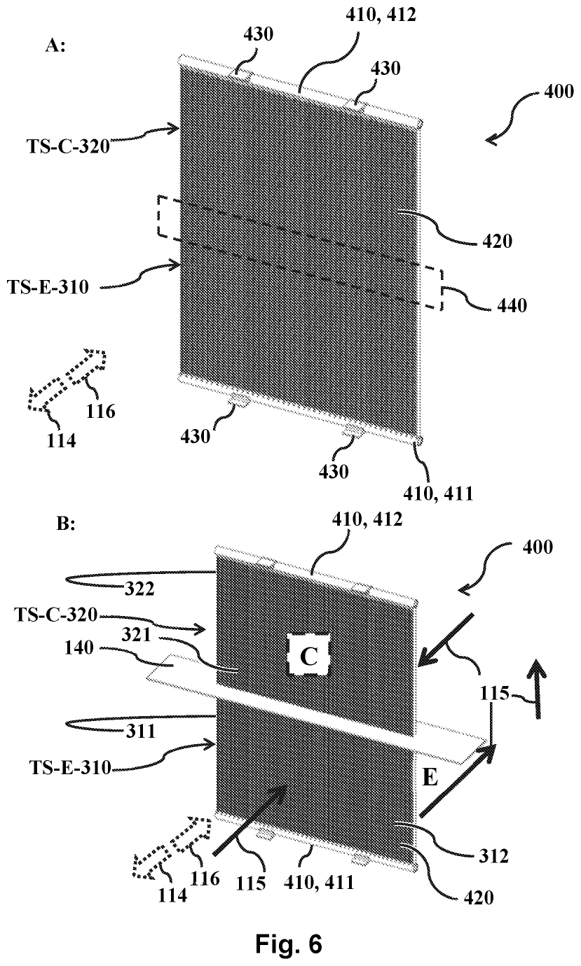

FIG. 6 illustrates an embodiment of a thermosiphon arrangement 300 as a thermosiphon block 400.

FIG. 6A shows a thermosiphon block 400 configured for a refrigerant 302 to circulate between a first header 411, here working as an evaporator header, and a second header 412, here working as a condenser header. The first and second headers 411, 412 are interconnected with a fluid communicator arrangement 420 here comprising multiple MPE-tubes with fins in-between. The thermosiphon block 400 is sealed and contains a refrigerant 302. The thermosiphon block 400 is here shown with connection means 430 enabling installation in a top-down orientation making the first header 411 install at a lower gravitational level than the second header 412 and thus when installed as suggested in the following figures resulting in the first header 411 being an evaporator header and the second header 412 being a condenser header. Installing the thermosiphon block in a housing with an evaporator and a condenser as will be described in the subsequent figures will define the thermosiphon evaporator part TS-E-310 and the thermosiphon condenser part TS-C-320. In-between there may or will be an adiabatic zone 440 with an extent that is determined by the actual placement of the faces.

FIG. 6B shows the thermosiphon block 400 from FIG. 6A with a partition plate or separator 140 installed between the first and second headers 411,412. The separator 140 may be part of a wall to be fitted to guide the airstream when installed. For illustrative purpose an airstream 115 is shown to exemplify the working during intended use. The shown embodiment in this orientation is a vertical thermosiphon block where the transfer of heat is essentially in the vertical direction during operation.

The airstream 115 will penetrate the thermosiphon evaporator part TS-E-310 from a thermosiphon evaporator part upstream face 312, circulate and penetrate the thermosiphon condenser part TS-C-320 from a thermosiphon condenser part upstream face 322.

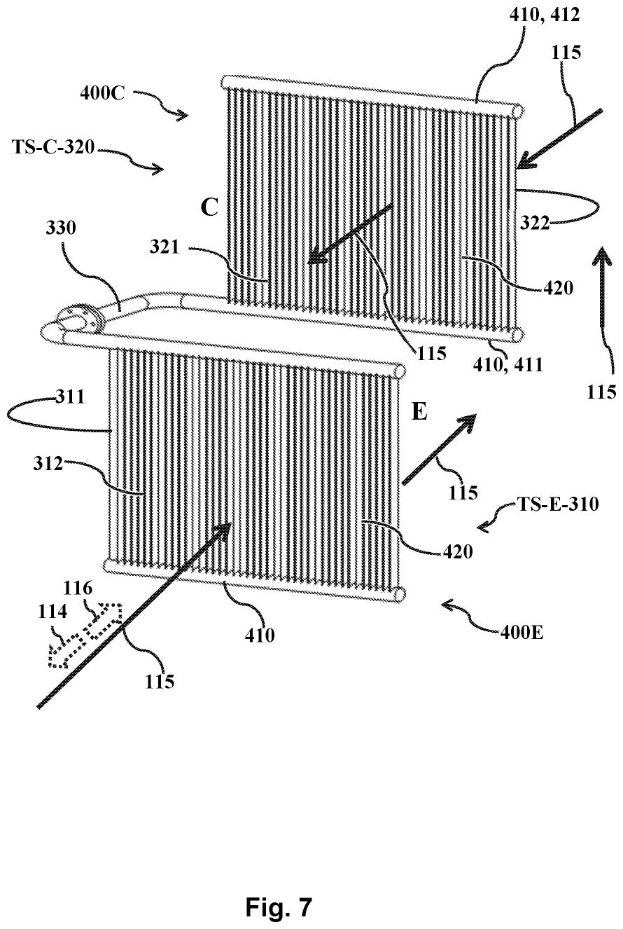

FIG. 7 illustrates an embodiment of a thermosiphon arrangement 300. The embodiment shows two modified thermosiphon blocks 400. One block as a condenser thermosiphon block 400C operating as the thermosiphon condenser part TS-C-320 and another as an evaporator thermosiphon block 400E operating as the thermosiphon evaporator part TS-E-310. The two blocks are modified by the first header 411 (the lower and evaporator header) of the thermosiphon condenser part TS-C-320 being in fluid communication with the second header (the upper and condenser header) of the thermosiphon evaporator part TS-E-310 via a fluid connection.

An airstream 115 as in intended operation is shown. The airstream 115 will penetrate the thermosiphon evaporator part TS-E-310 from a thermosiphon evaporator part upstream face 312, circulate and penetrate the thermosiphon condenser part TS-C-310 from a thermosiphon condenser part upstream face 322.

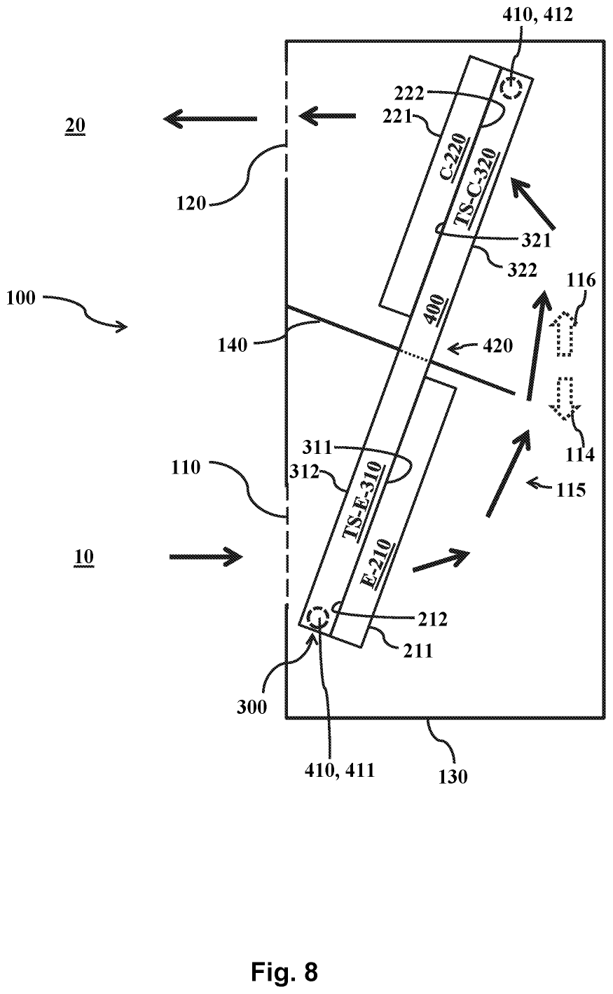

FIG. 8 illustrates a dehumidifier 100 comprising a different embodiment of a thermosiphon arrangement 300.

The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more walls (not shown) to control the airflow 115 such that the pressure loss through the dehumidifier 100 is as low as possible. The skilled person would know how to position the one or more walls.

The dehumidifier 100 has along the airstream 115, an evaporator E-210 and a condenser C-220. Although not shown, the evaporator E-210 and the condenser C-220 are interconnected, such that a refrigerant 302 may flow.

The evaporator E-210 has an evaporator downstream face 211 facing the downstream 116 and an evaporator upstream face 212 facing the upstream 114.

The condenser C-220 has a condenser downstream face 221 facing the downstream 116 and a condenser upstream face 222 facing the upstream 114.

The thermosiphon arrangement 300 comprises a thermosiphon block 400 having two headers 410. The first header 411 is the evaporator part header 411 and the second header 412 is the condenser part header 412. The headers 410 are interconnected by a fluid communicator arrangement 420 for liquid communications of a refrigerant 302.

The thermosiphon block 400 is divided by at least one separator 140 into a thermosiphon evaporator part TS-E-310 and a thermosiphon condenser part TS-C-320.

The thermosiphon evaporator part TS-E-310 has a thermosiphon evaporator part downstream face 311 facing downstream 116 and a thermosiphon evaporator part upstream face 312 facing upstream 114.

The thermosiphon condenser part TS-C-320 has a thermosiphon condenser part downstream face 321 facing downstream 116 and a thermosiphon condenser part upstream face 322 facing upstream 114.

The evaporators 210, 310 and condensers 220, 320 are positioned as described below. It is seen that the thermosiphon evaporator part upstream face 312 substantially faces the inlet 110.

It is seen that the thermosiphon evaporator part downstream face 311 substantially faces the evaporator upstream face 212.

It is seen that the evaporator downstream face 211 substantially faces the thermosiphon condenser part upstream face 322.

It is seen that the thermosiphon condenser part downstream face 321 substantially faces the condenser upstream face 222.

It is seen that the condenser downstream face 221 substantially faces the outlet 120.

The evaporators 210, 310 and condensers 220, 320 are aligned such that the pressure loss through the dehumidifier 100 is kept at a minimum as pressure loss lowers the efficiency of the dehumidifier 100.

The thermosiphon arrangement 300 is a passive element. The thermosiphon evaporator part TS-E-310 will lower the temperature of the ambient air 10. The air temperature will be closer to the dew point and thus the work needed to be performed by the evaporator E-210 will be lower. The air will afterwards be heated by the thermosiphon condenser part TS-C-320, thereby ensuring flow of the refrigerant 302. Afterwards the active condenser C-220 will heat the dehumidified air.

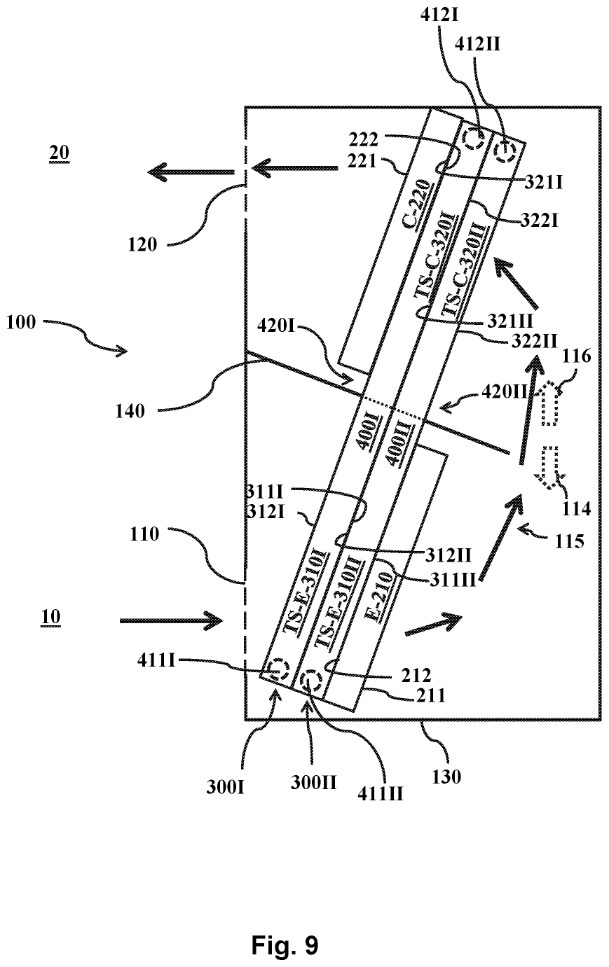

FIG. 9 illustrates a dehumidifier 100 comprising two thermosiphon arrangements 300I, 300II.

The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more walls (not shown) to control the airflow 115 such that the pressure loss through the dehumidifier 100 is as low as possible. The skilled person would know how to position the one or more walls.

The dehumidifier 100 has along the airstream 115, an evaporator E-210 and a condenser C-220. Although not shown, the evaporator E-210 and the condenser C-220 are interconnected, such that a refrigerant 302 may flow.

The evaporator E-210 has an evaporator downstream face 211 facing the downstream 116 and an evaporator upstream face 212 facing the upstream 114.

The condenser C-220 has a condenser downstream face 221 facing the downstream 116 and a condenser upstream face 222 facing the upstream 114.

Each thermosiphon arrangement 300I, II comprises a thermosiphon block 400I, 400II having a first header 411I, 411II being the evaporator part header 411I, 411II and a second header 412I, 412II being the condenser part header 412I, 412II. The header 411I, 412I and 411II, 412II are interconnected by a fluid communicator arrangement 420I, 420II for liquid communications of a refrigerant 302.

Each thermosiphon block 400I, 400II is divided by at least one separator 140 into a thermosiphon evaporator part TS-E-310I, TS-E-310II and a thermosiphon condenser part TS-C-320I, TS-C-320II.

Each thermosiphon evaporator part TS-E-310I, TS-E-310II has a thermosiphon evaporator part downstream face 311I, 311II facing downstream 116 and a thermosiphon evaporator part upstream face 312I, 312II facing upstream 114.

Each thermosiphon condenser part TS-C-320I, TS-C-320II has a thermosiphon condenser part downstream face 321I, 321II facing downstream 116 and a thermosiphon condenser part upstream face 322I, 322II facing upstream 114.

The evaporators 210, 310I, 310II and condensers 220, 320I, 320II are positioned as described below.

It is seen that the thermosiphon evaporator part upstream face 312I substantially faces the inlet 110.

It is seen that the thermosiphon evaporator part downstream face 311I substantially faces the thermosiphon evaporator part upstream face 312II.

It is seen that the thermosiphon evaporator part downstream face 311II substantially faces the evaporator upstream face 212.

It is seen that the evaporator downstream face 211 substantially faces the thermosiphon condenser part upstream face 322II.

It is seen that the thermosiphon condenser part downstream face 321II substantially faces the thermosiphon condenser part upstream face 322I.

It is seen that the thermosiphon condenser part downstream face 321I substantially faces the condenser upstream face 222.

It is seen that the condenser downstream face 221 substantially faces the outlet 120.

The evaporators 210, 310I, 310II and condensers 220, 320I, 320II are aligned such that the pressure loss through the dehumidifier 100 is kept at a minimum as pressure loss lowers the efficiency of the dehumidifier 100.

The thermosiphon arrangements 300I, 300II are passive elements. The thermosiphon evaporator parts TS-E-310I, TS-E-310II will lower the temperature of the ambient air 10. The air temperature will be closer to the dew point and thus the work needed to be performed by the evaporator E-210 will be lower. The air will afterwards be heated by the thermosiphon condenser parts TS-C-320I, TS-C-320II, thereby ensuring flow of the refrigerant 302. Afterwards the active condenser C-220 will heat the dehumidified air.

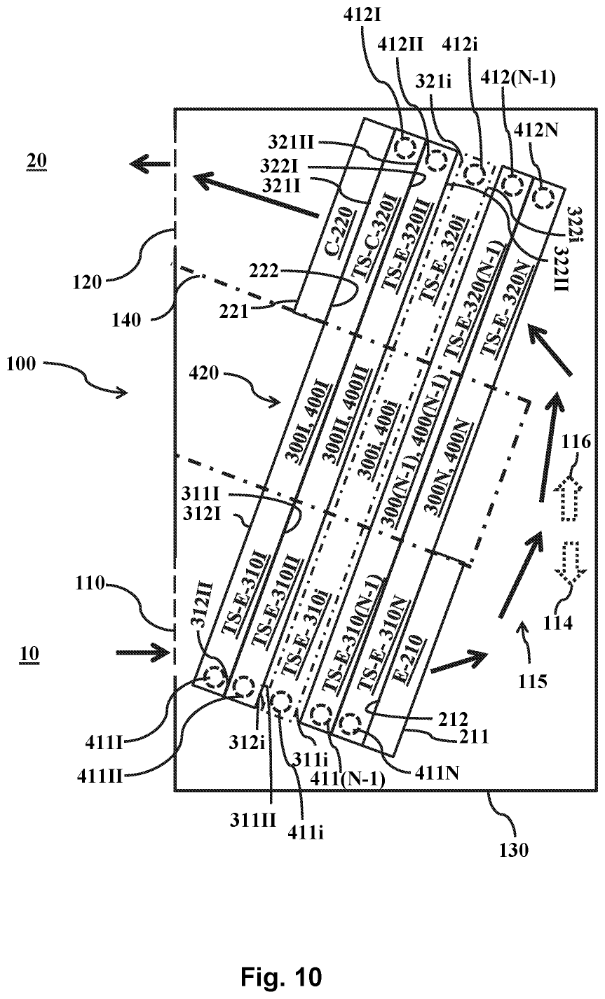

FIG. 10 illustrates a dehumidifier comprising N thermosiphon blocks as thermosiphon arrangements 300I . . . , 300N.

The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more walls (not shown) to control the airflow 115 such that the pressure loss through the dehumidifier 100 is as low as possible. The skilled person would know how to position the one or more walls.

The dehumidifier 100 has along the airstream 115, an evaporator E-210 and a condenser C-220. Although not shown, the evaporator E-210 and the condenser C-220 are interconnected, such that a refrigerant 302 may flow.

The evaporator E-210 has an evaporator downstream face 211 facing the downstream 116 and an evaporator upstream face 212 facing the upstream 114.

The condenser C-220 has a condenser downstream face 221 facing the downstream 116 and a condenser upstream face 222 facing the upstream 114.

Each thermosiphon arrangement 300I, . . . , 300N comprises a thermosiphon block 400I, . . . , 400N having a first header 411I, . . . , 411N being the evaporator part header 411I . . . , 411N and a second header 412I, . . . , 412N being the condenser part header 412I, . . . , 412N. The headers 411I and 412I, . . . , 411N and 412N are interconnected by a fluid communicator arrangement 420I, . . . , 420N for liquid communications of a refrigerant 302.

Each thermosiphon block 400I, . . . , 400N is divided by at least one separator 140 into a thermosiphon evaporator part TS-E-310I, TS-E-310N and a thermosiphon condenser part TS-C-320I, TS-C-320N.

Each thermosiphon evaporator part TS-E-310I, TS-E-310N has a thermosiphon evaporator part downstream face 311I, . . . , 311N facing downstream 116 and a thermosiphon evaporator part upstream face 312I, . . . , 312N.

Each thermosiphon condenser part TS-C-320I, TS-C-320N has a thermosiphon condenser part downstream face 321I, . . . , 321N facing downstream 116 and a thermosiphon condenser part upstream face 322I, . . . , 322N facing upstream 114.

The evaporators 210, 310I, 310i(i=2 to (N−1)), 310N and condensers 220, 320I, 320i(i=2 to (N−1)), 320N are positioned as described below.

It is seen that the thermosiphon evaporator part upstream face 312I substantially faces the inlet 110.

It is seen that the thermosiphon evaporator part downstream face 311I substantially faces the thermosiphon evaporator part upstream face 312II.

It is seen that the thermosiphon evaporator part downstream face 311i substantially faces the thermosiphon evaporator part upstream face 312(i+1).

It is seen that the thermosiphon evaporator part downstream face 311(N−1) substantially faces the thermosiphon evaporator part upstream face 312N.

It is seen that the thermosiphon evaporator part downstream face 311N substantially faces the evaporator upstream face 212.

It is seen that the evaporator downstream face 211 substantially faces the thermosiphon condenser part upstream face 322N.

It is seen that the thermosiphon condenser part downstream face 321N substantially faces the thermosiphon condenser part upstream face 322(N−1).

It is seen that the thermosiphon condenser part downstream face 321i substantially faces the thermosiphon condenser part upstream face 322(i−1).

It is seen that the thermosiphon condenser part downstream face 321II substantially faces the thermosiphon condenser part upstream face 322I.

It is seen that the thermosiphon condenser part downstream face 321I substantially faces the condenser upstream face 222.

It is seen that the condenser downstream face 221 substantially faces the outlet 120.

The evaporators 210, 210, 310I, 310i(i=2 to (N−1)), 310N and condensers 220, 320I, 320i(i=2 to (N−1)), 320N are aligned such that the pressure loss through the dehumidifier 100 is kept at a minimum as pressure loss lowers the efficiency of the dehumidifier 100.

The thermosiphon arrangements 300I . . . , 300N are passive elements. The thermosiphon evaporator parts TS-E-310I . . . , TS-E-310N will lower the temperature of the ambient air 10. The air temperature will be closer to the dew point and thus the work needed to be performed by the evaporator E-210 will be lower. The air will afterwards be heated by the thermosiphon condenser parts TS-C-320I . . . , TS-C-320N, thereby ensuring flow of the refrigerant 302. Afterwards the active condenser C-220 will heat the dehumidified air.

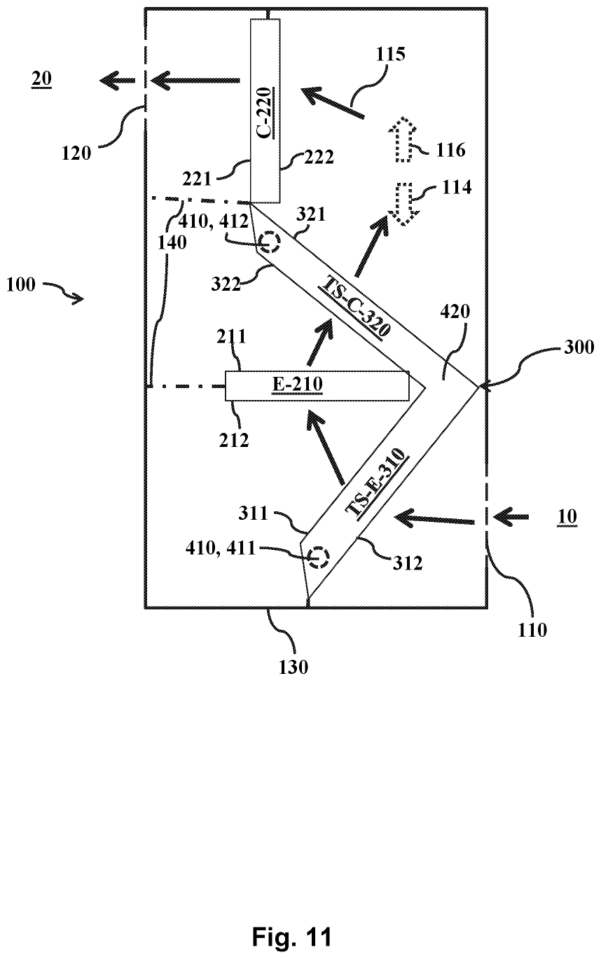

FIG. 11 illustrates a dehumidifier 100 comprising a bent thermosiphon arrangement 300.

The dehumidifier 100 has a housing 130 with an inlet 110 for intake of ambient air 10 and an outlet 120 for exhaust 20 of the air in the dehumidifier 100.

Airflow 115 is defined by the ambient air 10 flowing through the dehumidifier 100 from the inlet 110 towards the outlet 120. The airflow 115 defines two directions upstream 114 and downstream 116. Upstream 114 faces the opposite direction of the airflow 115. Downstream 116 faces the same direction as the airflow 115.

The dehumidifier 100 may have one or more separators 140 to control the airflow 115 such that the pressure loss through the dehumidifier 100 is as low as possible. The skilled person would know how to position the one or more walls.

The dehumidifier 100 has along the airstream 115, an evaporator E-210 and a condenser C-220. Although not shown, the evaporator E-210 and the condenser C-220 are interconnected, such that a refrigerant 302 may flow.

The evaporator E-210 has an evaporator downstream face 211 facing the downstream 116 and an evaporator upstream face 212 facing the upstream 114.

The condenser C-220 has a condenser downstream face 221 facing the downstream 116 and a condenser upstream face 222 facing the upstream 114.

The thermosiphon arrangement 300 comprises a thermosiphon block 400 having two headers 410. The first header 411 is the evaporator part header 411 and the second header 412 is the condenser part header 412. The headers 410 are interconnected by a fluid communicator arrangement 420 for liquid communications of a refrigerant 302.

In this embodiment the thermosiphon block 400 has a centrally positioned bent, thereby dividing the thermosiphon block 400 into a thermosiphon evaporator part TS-E-310 and a thermosiphon condenser part TS-C-320.

The thermosiphon evaporator part TS-E-310 has a thermosiphon evaporator part downstream face 311 facing downstream 116 and a thermosiphon evaporator part upstream face 312 facing upstream 114.

The thermosiphon condenser part TS-C-320 has a thermosiphon condenser part downstream face 321 facing downstream 116 and a thermosiphon condenser part upstream face 322 facing upstream 114.

The evaporators 210, 310 and condensers 220, 320 are positioned as described below.

It is seen that the thermosiphon evaporator part upstream face 312 substantially faces the inlet 110.

It is seen that the thermosiphon evaporator part downstream face 311 substantially faces the evaporator upstream face 212.

It is seen that the evaporator downstream face 211 substantially faces the thermosiphon condenser part upstream face 322.

It is seen that the thermosiphon condenser part downstream face 321 substantially faces the condenser upstream face 222.

It is seen that the condenser downstream face 221 substantially faces the outlet 120.

The evaporators 210, 310 and condensers 220, 320 are aligned such that the pressure loss through the dehumidifier 100 is kept at a minimum as pressure loss lowers the efficiency of the dehumidifier 100.

The thermosiphon arrangement 300 is a passive element. The thermosiphon evaporator part TS-E-310 will lower the temperature of the ambient air 10. The air temperature will be closer to the dew point and thus the work needed to be performed by the evaporator E-210 will be lower. The air will afterwards be heated by the thermosiphon condenser part TS-C-320, thereby ensuring flow of the refrigerant 302. Afterwards the active condenser C-220 will heat the dehumidified air.

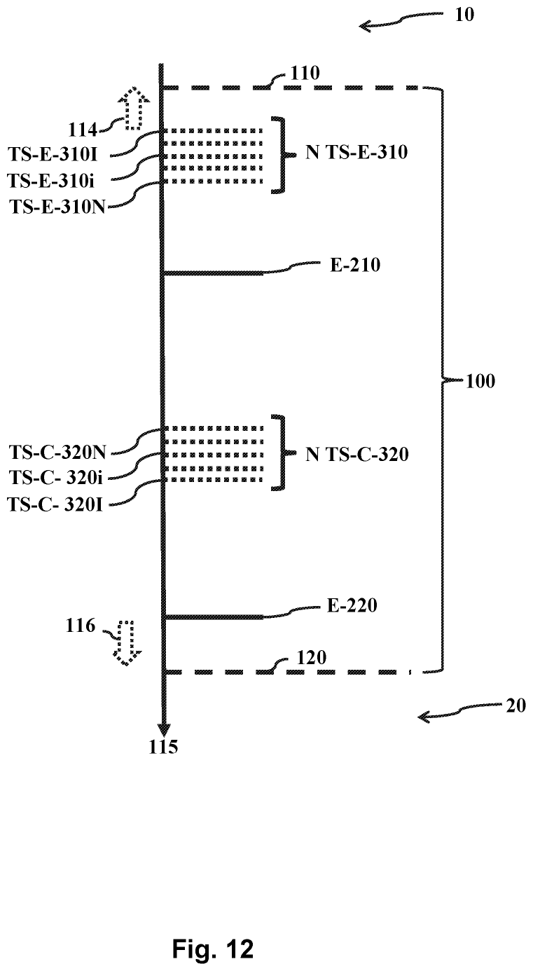

FIG. 12 illustrates a dehumidifier 100 projected onto an airstream 115. The airstream 115 is formed by the ambient air 10 entering the dehumidifier 100 at an inlet and exiting the dehumidifier at an outlet 120 as exhaust 20 being dehumidified air.

The airflow 115 defines two directions upstream 114 and downstream 116. Upstream 114 faces the opposite direction of the airflow 115. Downstream 116 faces the same direction as the airflow 115.

The figure discloses in which order the airstream 115 passes evaporators and condensers.

The order is as followed:
First the airstream passes the evaporators in the order of TS-E-310I, TS-E-310i (i=2 to (N−1)), TS-E-310N, E-210.
Then the airstream passes the condensers in the order of TS-C-320N, TS-C-320i (i=(N−1) to 2), TS-C-320I, C-220.

The different embodiments of the dehumidifiers 100 all follow the above mentioned order. The only difference being whether N=1 or N=2 or N equals another whole number.

1. A dehumidifier for dehumidifying ambient air in an airstream, the dehumidifier comprising:
an evaporator having an evaporator downstream face and an evaporator upstream face;
a condenser having a condenser downstream face and a condenser upstream face, the condenser being positioned downstream from the evaporator; and
a first thermosiphon arrangement including a first thermosiphon evaporator part upstream from the evaporator, and a first thermosiphon condenser part upstream from the condenser and downstream from the evaporator;
wherein the thermosiphon evaporator part and the thermosiphon condenser part each include
a first header,
a second header, and
a thermosiphon block configured to communicate a refrigerant between the first header and the second header, the first and second headers are interconnected with a fluid communicator arrangement having multiple tubes,
wherein the thermosiphon block is sealed and each contain the refrigerant; and
wherein the thermosiphon evaporator part is interconnected with the thermosiphon condenser part.

2. The dehumidifier according to claim 1, wherein the multiple tubes are MPE-tubes.

3. The dehumidifier according to claim 1, wherein the fluid communicator arrangement of the first thermosiphon evaporator part includes a thermosiphon evaporator part downstream face substantially facing the evaporator upstream face.

4. The dehumidifier (100) according to claim 1, wherein the fluid communicator arrangement of the first thermosiphon condenser part includes a thermosiphon condenser part downstream face (321) substantially facing the condenser upstream face (222).

5. The dehumidifier of claim 1, further comprising a second thermosiphon arrangement arranged with a second thermosiphon evaporator part downstream from the first thermosiphon evaporator part between the first thermosiphon evaporator part and the evaporator, and a second thermosiphon condenser part upstream from the first thermosiphon condenser part between the evaporator and the first thermosiphon condenser part.

6. The dehumidifier of claim 1, wherein the first thermosiphon arrangement includes a first thermosiphon block and the second thermosiphon arrangement includes a second thermosiphon block.

7. The dehumidifier according to claim 6, wherein the first thermosiphon block and the second thermosiphon block are sandwiched with
the first thermosiphon evaporator part downstream face substantially facing the second thermosiphon evaporator part upstream face;
the first thermosiphon condenser part upstream face substantially facing the second thermosiphon condenser part downstream face;
the second thermosiphon evaporator part downstream face substantially facing the evaporator upstream face; and
the first thermosiphon condenser part downstream face substantially facing the condenser upstream face.

8. The dehumidifier according to claim 1, the first thermosiphon arrangement further comprising additional thermosiphon arrangements, each i'th thermosiphon arrangement arranged with an i'th thermosiphon evaporator part downstream from an (i−1)'th thermosiphon evaporator part and an i'th thermosiphon condenser part upstream from the (i−1)'th thermosiphon condenser part.

9. The dehumidifier according to claim 1, wherein the first thermosiphon arrangement includes a first thermosiphon block and the Nth thermosiphon arrangement includes a Nth thermosiphon block.

10. The dehumidifier according to claim 9, wherein the N thermosiphon blocks are sandwiched with
the (i−1)'th thermosiphon evaporator part downstream face substantially facing the i'th thermosiphon evaporator part upstream face;
the (i−1)'th thermosiphon condenser part upstream face substantially facing the i'th thermosiphon condenser part downstream face;
the N'th thermosiphon evaporator part downstream face substantially facing the evaporator upstream face; and
the first thermosiphon evaporator part downstream face substantially facing the condenser upstream face.

11. (canceled)

12. A dehumidifier for dehumidifying ambient air in an airstream, the dehumidifier comprising:
an evaporator having an evaporator downstream face and an evaporator upstream face;
a condenser, downstream from the evaporator, having a condenser downstream face and a condenser upstream face; and
a thermosiphon arrangement including
a thermosiphon evaporator part upstream from the evaporator,
a thermosiphon condenser part upstream from the condenser and downstream from the evaporator, and
a thermosiphon block configured to communicate a refrigerant between a first header and a second header interconnected with a fluid communicator arrangement including multiple tubes,
wherein the thermosiphon block is sealed and contains the refrigerant.

13. The dehumidifier according to claim 12, wherein the multiple tubes are MPE-tubes.

14. The dehumidifier according to claim 12, wherein the fluid communicator arrangement of the thermosiphon block has a part that is the thermosiphon evaporator part having a thermosiphon evaporator part downstream face substantially facing the evaporator upstream face.

15. The dehumidifier according to claim 12, wherein the fluid communicator arrangement of the thermosiphon block has a part that is the thermosiphon condenser part having a thermosiphon condenser part downstream face substantially facing the condenser upstream face.
